(19) United States
(12) Patent Application Publication
(10) Pub. No.: US 2010/0230935 A1
(43) Pub. Date: Sep. 16, 2010

(54) VEHICLE AIRBAG MODULE

(76) Inventors: Larry D. Rose, South Weber, UT (US); Robert Lewis, West Haven, UT (US); Trudy Lewis, West Haven, UT (US)

Correspondence Address: Sally J. Brown;AUTOLIV ASP, INC., 3350 Airport Road, Ogden, UT, 84405, US

(21) Appl. No.: 12/402,266

(22) Filed: Mar. 11, 2009

(51) Int. Cl. B60R 21/16

(52) U.S. Cl. 280/728.2

(57) ABSTRACT

An airbag module protects a rider in a vehicle from impacting the interior of the occupant enclosure of the vehicle. A rigid support collar is attached to the occupant enclosure proximate an airbag deployment window. An inflatable cushion has a neck portion that accommodates pressurized gas for driving the cushion through the deployment window into an inflated condition in the occupant enclosure. The cushion is attached by the neck portion directly to the support collar, while that substantial balance of the cushion is housed in a compact condition within the support collar. An attachment tab is secured to the exterior of the neck portion of the cushion with a restraining aperture formed therethrough. A cushion hook on the exterior of the support collar extends through the restraining aperture and prevents displacement of the neck portion of the cushion out of the support collar, when pressurized gas inflates the cushion. The cushion includes a flexible packaging cover having opposed first and second edges. The first edge is secured to the neck portion of the cushion, and the second edge is attached directly to support collar, while the packaging cover therebetween extends across the support collar retaining therein the cushion in the compact condition thereof.

### BACKGROUND OF THE INVENTION

1. Field of the Invention

The present invention pertains to maintaining the safety of riders in highway vehicles. More particularly, the present invention pertains to airbags for protecting a rider in a vehicle from impact with the interior of the occupant enclosure of the vehicle.

2. Background of the Invention

Inflatable safety restraint devices, or airbags, are now legally mandated in most new highway vehicles. Airbags are typically included at least in the steering wheel and in the dashboard on the passenger side of a highway vehicle. In addition, such airbags are occasionally installed to inflate beside a vehicle occupant and provide side impact protection, to inflate in front of the legs and protect the knees from forward impact, or to inflate at other strategic locations within the occupant enclosure of a highway vehicle.

In the event of an accident, a sensor system within the vehicle detects an impact situation and triggers the ignition of an inflator. Pressurized gases from the inflator immediately fills the inflatable cushion causing the airbag cushion to deploy, which then protects a vehicle rider from impacting against the interior surfaces of the occupant enclosure. During normal vehicle operation, airbags are typically stowed behind covers that deter tampering and serve as visually attractive interior facades.

Passenger-side frontal impact airbags are commonly installed behind an upper surface of the instrument panel of the vehicle in proximity to an airbag deployment window formed therethrough. An associated inflator is also installed behind the instrument panel in such a manner that pressurized gas therefrom flows upwardly, causing the cushion of the airbag to expand through the airbag deployment window and into the occupant enclosure of the vehicle. The folded cushion and the inflator are typically packaged in an airbag housing that is secured to the opposite side of the instrument panel from the occupant enclosure, holding the inflator for eventual ignition and the cushion for eventual deployment. During deployment of the cushion, it is the housing that secures the inflator and the inflated cushion to the instrument panel. Typically, the housing is formed of sheet metal or the like.

Current airbag housings exhibit disadvantages, however.

An airbag housing is a complicated structure that adds significantly to the material and labor costs of a finished airbag module. The housing is typically produced in distinct dedicated manufacturing steps, separately from the other components of the airbag module. The inflator and the cushion are then each disposed in and attached to the housing procedures that are labor intensive and, therefore, relatively time consuming.

The housing itself is a heavy structure that contributes a significant fraction of the weight of a finished airbag module, detrimentally increasing the overall weight and decreasing the fuel consumption efficiency of the vehicle in which the airbag module is installed.

### BRIEF SUMMARY OF THE INVENTION

According to teachings of the present invention, an airbag module for protecting a rider in a vehicle from impacting the interior of the occupant enclosure of the vehicle includes a rigid support collar and an inflatable cushion. The support collar is designed for attachment to the occupant enclosure at an airbag deployment window formed therethrough. The inflatable cushion has a neck portion that accommodates pressurized gas for driving the cushion through the deployment window into an inflated condition of the cushion in the occupant enclosure. The neck portion of the cushion is attached directly to the support collar, and the cushion is housed in a compact condition within the support collar.

An attachment tab is secured to the exterior of the neck portion of the cushion, and a restraining aperture is formed through the attachment tab. Correspondingly, a cushion hook on the exterior of the support collar extends through the restraining aperture, thereby preventing the displacement of the neck portion of the cushion out of the support collar when pressurized gas inflates the cushion. The cushion hook opens away from the occupant enclosure when the support collar is attached to the exterior of the occupant enclosure, and the portion of the attachment tab on the side of the restraining aperture opposite from the neck of the cushion is captured in the cushion hook.

In an additional aspect of the present invention, the inflatable cushion of an airbag module includes an elongated flexible attachment tab having a longitudinal securement edge attached to the exterior of the neck of the cushion and a free edge remote therefrom. A plurality of restraining apertures is formed through the attachment tab in a spaced-apart relationship parallel to the securement edge thereof. A plurality of cushion hooks on the exterior of the support collar correspond in number and in spaced-apart positioning to the plurality of the restraining apertures. Each of the cushion hooks extends through one of the restraining apertures, capturing the portion of the attachment tab located between the restraining aperture and the free end of the attachment tab.

In yet another aspect of the present invention, the inflatable cushion of an airbag module includes a plurality of flexible attachment tabs circumscribing the exterior of the neck of the cushion in a spaced-apart relationship. Each of the attachment tabs has a securement edge attached to the exterior of the neck of the cushion and a free edge remote therefrom. A restraining aperture is associated with and formed through each of the attachment tabs between the securement edge and the free edge thereof. A circumscribing plurality of cushion hooks project from the exterior of the support collar in a one-to-one positional correspondence to individual of the restraining apertures. Each of the cushion hooks extends through one of the restraining apertures and captures the portion of the attachment tab associated therewith that is located between the restraining apertures and the free edge of that attachment tab. The plurality of cushion hooks thereby cooperate with the attachment tab in absorbing at the neck of the cushion snap-loads arising when pressurized gas fully inflates the cushion.

The inflatable cushion is provided with a flexible packaging cover that has opposed first and second edges. The first edge of the packaging cover is secured to the neck of the cushion, and the packaging cover is stretched from that first edge across a support collar in which the cushion is housed in a compact condition. Then the second edge of the packaging cover is attached directly to the support collar by the interaction of a restraining aperture formed through the second edge of the packaging cover and a cushion hook on the exterior periphery of the support collar. The cushion hook extends through the restraining aperture and prevents the withdrawal of the packaging cover from across the support collar.

According to additional teachings of the present invention, a support collar for an inflatable cushion for an airbag module assumes the form of a closed loop configured to circumscribe an airbag deployment window formed through the occupant enclosure. A plurality of cushion hooks circumscribes the exterior of the support collar in a spaced-apart relationship. Each of the cushion hooks opens away from the occupant enclosure, when the support collar is attached to the exterior thereof, and each of the cushion hooks interacts with features on the neck portion of the inflatable cushion to prevent displacement of the neck of the cushion out of the support collar, when pressurized gas inflates the cushion.

The teachings of the present invention also include an airbag module that includes an inflatable cushion, a rigid support collar for attachment to the exterior of an occupant enclosure at an airbag deployment window, and an inflator that produces pressurized gas in response to an electrical activation signal. In an exemplary embodiment, the cushion has three distinct portions defined by respective functions. An enlarged closed-ended inflation portion of the cushion is housed in a compact condition in proximity to the deployment window, but is capable of being driven by pressurized gas through the deployment window into an inflated condition inside of the occupant enclosure. A relatively small activation portion of the cushion is maintained in a substantially unchanged disposition exterior of the occupant enclosure during all conditions of the inflation portion. A neck portion of the cushion interconnects the inflation portion and the activation portion in a fluid-tight communication that accommodates the transfer of pressurized gas from the activation portion into the inflation portion. The support collar is attached in a circumscribing relation to the exterior of the neck portion of the cushion, while also housing the inflation portion of the cushion in the compact condition thereof. The inflator is attached to the activation portion of the cushion in fluid communication with the interior thereof. A retainer ring is secured through a wall of the activation portion of the cushion to the inflator, and a mounting bracket secured to the inflator supports the inflator from a structural element of the vehicle in which the airbag module is employed.

An inflatable cushion as described above further includes a flexible packaging cover having opposed first and second edges. The first edge of the packaging cover is secured to the neck portion of the cushion, while the packaging cover itself extends therefrom across the support collar closing therein the inflation portion of the cushion in the compact condition thereof. The second edge of the packaging cover is secured to the support collar. The cushion also includes a flexible attachment tab that is secured to the exterior of the neck portion of cushion with a restraining aperture formed therethrough. Correspondingly, a cushion hook on the exterior periphery of the support collar extends through the restraining aperture and prevents the displacement of the neck portion of the cushion out of the support collar, when pressurized gas inflates the inflation portion of the cushion.

An airbag module incorporating teachings of the present invention includes two distinct sections defined by the manner in which each is stowed in a vehicle and stabilized during deployment of the airbag module. A deployment section of the airbag module is attachable to the occupant enclosure of the vehicle at an airbag deployment window formed therethrough. The deployment section is capable of both, being driven to position a gas-inflated impact-absorbing cushion in the interior of the occupant enclosure by way of the deployment window, and absorbing snap-loads arising from so positioning the cushion. An energizer section of the airbag module is capable of being supported from the vehicle independently of the deployment section. The energizer section is in inflation communication with the deployment section. The energizer section delivers pressurized gas to the deployment section, when an impact is imminent between a rider and the interior of the occupant enclosure.

The deployment section includes an inflatable cushion and a rigid support collar for attachment to the occupant enclosure at an airbag deployment window. The cushion includes an enlarged closed-ended inflation portion that is housed in a compact condition in proximity to the deployment window and that is capable of being driven by pressurized gas through the deployment window into an inflated condition thereof in the occupant enclosure. A neck portion of the cushion is in fluid-tight communication with the inflation portion of the cushion and the energizer section of the airbag module, thereby to accommodate the transfer of pressurized gas from the energizer section of the airbag module into the inflation portion of the cushion. The support collar is attached in a circumscribing relationship to the exterior of the neck portion of the cushion, while also housing the inflation portion of the cushion in the compact condition thereof. The support collar assumes the form of a substantially planar closed loop capable of resisting radial expansion of the neck portion of the cushion caused by deployment loading as the inflation portion of the cushion is being driven by pressurized gas through the deployment window.

The energizer section of the airbag module includes a relatively small activation portion of the cushion that is maintained in substantially unchanged disposition exterior of the occupant enclosure during all conditions of the inflation portion of said cushion. An inflator produces pressurized gas in response to an activation signal and is attached to the activation portion of the cushion in fluid communication with the interior thereof by a retainer ring secured through a wall of the activation portion of the cushion to the inflator. A mounting bracket secured to inflator is capable of supporting the inflator from a structural element of the vehicle.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is a side elevation view in partial cross section of an embodiment of an airbag module incorporating teachings of the present invention and mounted in the installed state thereof in readiness as a passenger-side frontal impact protection feature behind the instrument panel portion of the occupant enclosure of a highway vehicle;

FIG. 1B depicts the same subject matter as that shown in FIG. 1A with the inflatable cushion of the airbag module from FIG. 1A deployed in an inflated state thereof in the occupant enclosure;

FIG. 2 is an exploded perspective view of components of the inflatable cushion of the airbag module of FIG. 1B;

FIG. 3A is a disassembled perspective view of an end of the cushion of the airbag module of FIG. 1B and of an inflator therefor;

FIG. 3B is a disassembled perspective view of the inflator end of the cushion of FIG. 3A and a support collar therefor;

FIG. 3C is an assembled perspective view of the elements of the cushion of the airbag module of FIG. 3B;

FIG. 3D is perspective view of the airbag module of FIG. 3C in a packaged condition with a packaging cover retaining the cushion of the airbag module in a compact condition within the support collar thereof;

FIG. 4 is an enlarged detailed perspective view of the portion of FIG. 3D within detail arrow 4-4 therein;

FIG. 5 is an elevation cross section of FIG. 4 taken along section line 5-5 therein;

FIGS. 6A-6C form a series of perspective illustrations in partial cross section that depict stages in the deployment of the inflatable cushion of the airbag module of FIG. 3D, namely with FIG. 6A illustrating the airbag module installed on the exterior of an occupant enclosure at an airbag deployment window formed therethrough, with FIG. 6B illustrating the airbag module at an initial stage of activation prior to the breakout of the cushion through the deployment window, and with FIG. 6C illustrating the airbag module at a final stage of deployment with the cushion thereof fully inflated through the deployment window into the occupant enclosure.

### DETAILED DESCRIPTION OF THE INVENTION

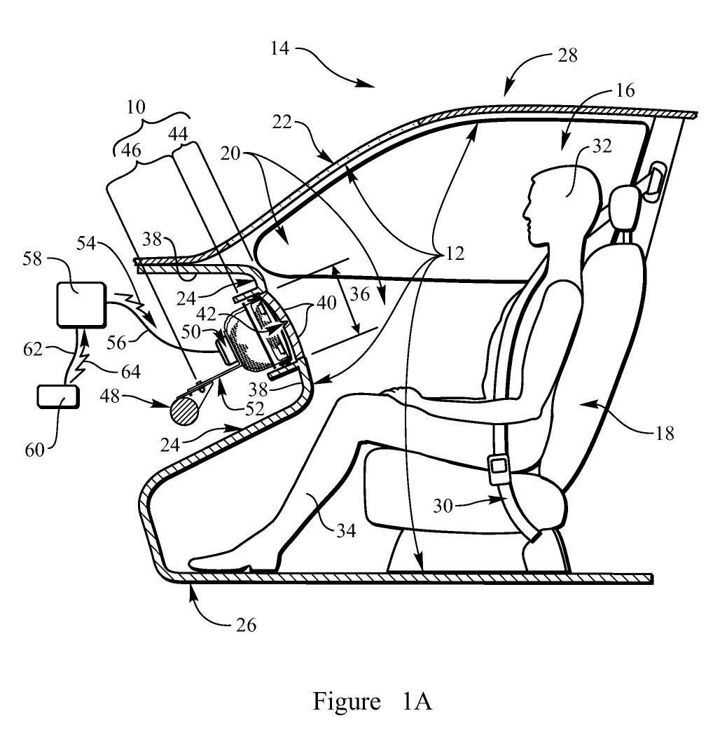

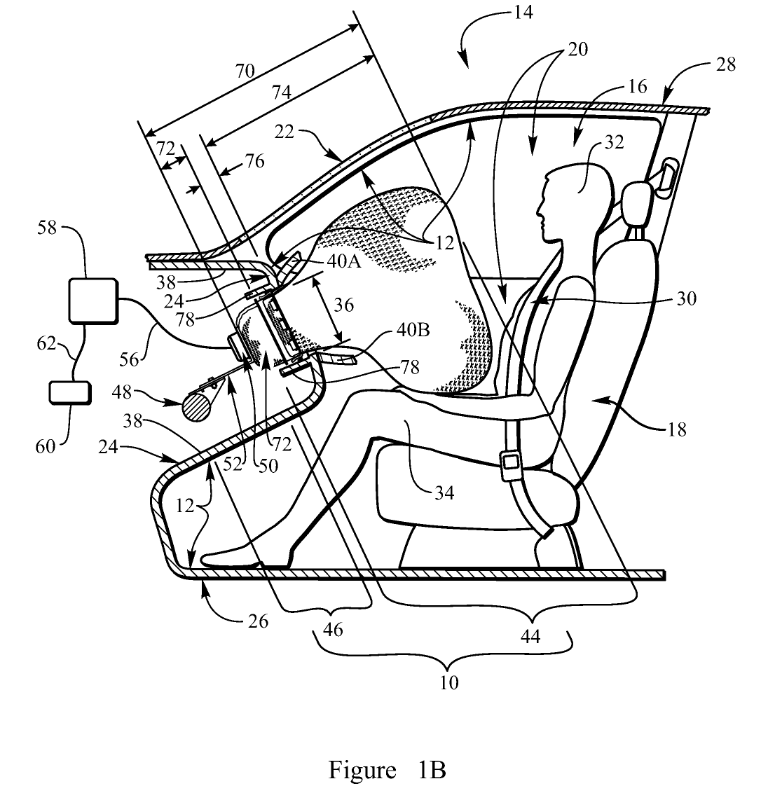

The present invention will be best understood by reference to the drawings, wherein like parts are designated by like numerals throughout. It should be understood that the components of the present invention, as generally described and illustrated in the figures herein, could be arranged and designed in a variety of different configurations. Thus, the following detailed description of an embodiment of the apparatus, system, and method of the present invention, as depicted in FIGS. 1A-7C, is not intended to limit the scope of the invention as claimed.

In this application, the phrases “connected to”, “coupled to”, and “in communication with” refer to any form of interaction between two or more entities, including mechanical, electrical, magnetic, electromagnetic, pneumatic, and thermal interactions.

The phrases “attached to”, “secured to”, and “mounted to” refer to a form of mechanical coupling that restricts relative translation or rotation between the attached, secured, or mounted object, respectively. The phrases “pivotally attached to” and “slidably attached to” refer to forms of mechanical coupling that permit relative rotation or relative translation, respectively, while restricting other relative motions. The phrase “attached directly to” refers to a form of securement in which the secured items are in direct contact and retained in that state of securement without resort to fasteners or adhesives.

The term “abutting” refers to items that are in direct physical contact with each other, although the items may not be attached together. The term “grip” refers to items that are in direct physical contact with one of the items firmly holding the other. The term “integrally formed” refers to a body that is manufactured as a single piece, without requiring the assembly of constituent elements. Multiple elements may be integrally formed with each other, when attached directly to each other from a single work piece. Thus, elements that are “coupled to” each other may be formed together as a single piece.

FIG. 1A is a side elevation view in partial cross section of an embodiment of an airbag module 10 incorporating teachings of the present invention and mounted in an installed state thereof as a passenger-side frontal impact protection feature at the instrument panel portion of the occupant enclosure 12 of a highway vehicle 14. In the installed state, airbag module 10 is ready to provide protection to a rider 16 seated within the interior of occupant enclosure 12. It should be understood, however, that the teachings of the present invention have applicability, not only to passenger-side frontal impact protection, but also to other forms of passenger protection, such as knee bolsters, overhead airbags, inflatable curtains, side airbags, inflatable structural stiffeners, and the like. Furthermore, the teachings of the present invention may be employed advantageously, not only in highway vehicles, but also in vehicles that travel over rails, from cables, on water, and through air or space.

As illustrated, vehicle 14 has a seat 18 on which rider 16 reposes, a door 20 beside rider 16, a windshield 22 and an instrument panel 24 in front of rider 16, a floor 26 below rider 16, and a ceiling 28 thereabove. Each of door 20, instrument panel 24, floor 26, ceiling 28, and even windshield 22 form a portion of occupant enclosure 12. A seat belt 30 affords the primary restraint for rider 16 in case of a collision involving vehicle 14, but airbag module 10 is provided in supplement thereto in order to protect, for example, the head 32 or the legs 34 of rider 16 from impacting the interior of occupant enclosure 12 during such a collision.

Airbag module 10 is attached to instrument panel 24 of the occupant enclosure 12 proximate an airbag deployment window 36 formed therethrough. As shown by way of example and not limitation, airbag module 10 is mounted on an exterior surface 38 of occupant enclosure 12 in proximity to deployment window 36. Alternatively an airbag module, such as airbag module 10, may be installed in a mounting recess formed in a side of occupant enclosure 12 that faces rider 16. In such instances, the mouth of the mounting recess also faces rider 16 and functions as an airbag deployment window in the same manner as deployment window 36. Accordingly, as used herein, the expression “deployment window” when applied to a vehicle airbag module is intended to refer to any opening through which the airbag module is afforded access to the interior of the occupant enclosure of the vehicle.

As shown in FIG. 1A, a concealment panel 40 is positioned in deployment window 36 to protect airbag module 10 from inadvertent damage and to obscure airbag module 10 from the view of rider 16. Concealment panel 40 is designed to open only when airbag module 10 is being deployed. Thus, the center of the side of concealment panel 40 facing airbag module 10 is longitudinally scored by a release grove 42. Release grove 42 allows concealment panel 40 to split apart during deployment of airbag module 10, opening deployment window 36 and affording access for airbag module 10 through deployment window 36 to occupant enclosure 12.

By way of overview, airbag module 10 includes a deployment section 44 that is attached to occupant enclosure 12 at deployment window 36 and an energizer section 46 that is supported independently from deployment section 44 on a structural element 48 of vehicle 14. Deployment section 44 houses in a compact condition a gas-inflatable, impact-absorbing cushion.

Energizer section 46 of airbag module 10 is manufactured in inflation communication with deployment section 44. Energizer section 46 generates and delivers pressurized gas to deployment section 44, when an impact is imminent between rider 16 and the interior of occupant enclosure 12. Toward that end, energizer section 46 includes an inflator 50 that produces the pressurized gas for deployment section 44 and a mounting bracket 52 secured to inflator 50 by which inflator 50 is supported from structural element 48 of vehicle 14. Inflator 50 is, for example, a compressed gas inflator, a pyrotechnic inflator, a hybrid inflator, or any other type of device that generates pressurized gas with extreme dispatch. The activation of inflator 50 is typically triggered electrically.

An activation signal 54 for inflator 50 is received along an electrical wire 56 that is coupled between inflator 50 and an electronic control unit 58 for vehicle 14 that is installed at any convenient position therein. Activation signal 54 is generated by the combined activity of electronic control unit 58 and a collision sensor 60 that is electrically interconnected therewith by an additional electrical wire 62. Collision sensor 60, which may, for example, take the form of an accelerometer, is also installed at convenient locations within vehicle 14. When a collision by vehicle 14 is occurring or is about to occur, collision sensor 60 transmits a corresponding warning signal 64 along electrical wire 62 to electronic control unit 58. Electronic control unit 58 processes warning signal 64 and generates activation signal 54, which is transmitted along electrical wire 56 triggering inflator 50.

FIG. 1B depicts the consequence of triggering inflator 50 in this manner. The airbag module 10 has assumed the deployed state thereof, extending in part through deployment window 36 into occupant enclosure 12. Compressed gas from inflator 50 has been communicated from energizer section 46 of airbag module 10 into deployment section 44 thereof, filling to capacity an inflatable cushion 70 of airbag module 10. A relatively small activation portion 72 of cushion 70 located between inflator 50 and energizer section 46 of airbag module 10 is maintained in a substantially unchanged disposition during deployment of airbag module 10.

By contrast, an enlarged closed-ended inflation portion 74 of cushion 70, which had in FIG. 1A been housed in a compact condition within deployment section 44 of airbag module 10, is driven by the pressurized gas from inflator 50 initially against the side of concealment panel 40 adjacent to airbag module 10. As shown in FIG. 1B, this causes concealment panel 40 to split at release grove 42 into an upper concealment panel segment 40A and a lower concealment panel segment 40B. Under the continuing impetus of the expansion of inflation portion 74, each of upper concealment panel segment 40A and a lower concealment panel segment 40B pivoted about a respective portion of the periphery of deployment window 36 toward the interior of occupant enclosure 12, opening deployment window 36.

Through the thusly opened deployment window 36, inflation portion 74 of cushion 70 was then driven by the pressurized gas from inflator 50 into a fully inflated condition thereof in the interior of occupant enclosure 12 intermediate rider 16 and each of windshield 22 and instrument panel 24. The transfer of pressurized gas between activation portion 72 and inflation portion 74 of cushion 70 is accommodated through a neck portion 76 of cushion 70 that interconnects activation portion 72 and inflation portion 74. Neck portion 76 of cushion 70 is an element of deployment section 44 of airbag module 10 that, in contrast to inflation portion 74 of cushion 70, is maintained in a substantially unchanged disposition during deployment. To accomplish this, neck portion 76 is secured within an airbag installation bracket 78 to exterior surface 38 of occupant enclosure 12 in proximity to deployment window 36.

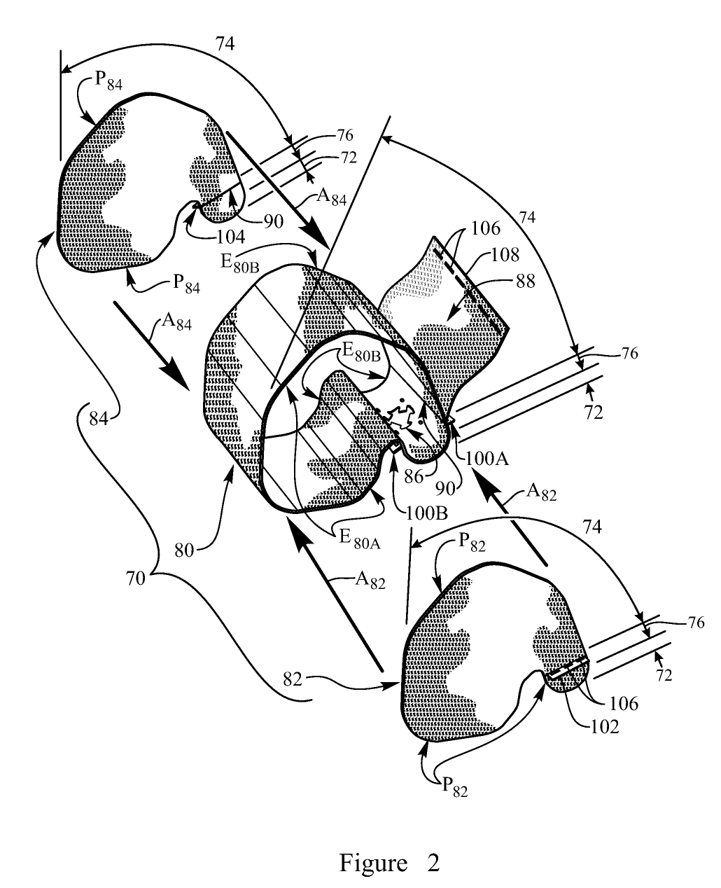

FIG. 2 is an exploded perspective view of components of inflatable cushion 70 of airbag module 10. Cushion 70 is there depicted as including a main panel 80 that forms a looped band, a planar near side panel 82 of irregular configuration, and a similarly configured planar far side panel 84. As suggested by arrows A₈₂, near side panel 82 is attached by the perimeter P₈₂ thereof to the near edge E_{80A} of the looped band formed by main panel 80. Similarly, as, suggested by arrows A₈₄, far side panel 84 is attached by the perimeter P₈₄ thereof to the far edge E_{80B} of main panel 80. When attached in this manner main panel 80, near side panel 82, and far side panel 84 form a closed, collapsible and inflatable structure suitable for employment in an airbag module, such as airbag module 10.

By way of enhanced correlation with the depiction of cushion 70 in FIG. 1B, identified in FIG. 2 are the portions of each of main panel 80, near side panel 82, and far side panel 84 that participate, respectively, in creating activation portion 72, inflation portion 74, and neck portion 76 of cushion 70. An inflation mouth 86 is formed through a central portion of main panel 80 that participates in creating activation portion 72 of cushion 70. It is through inflation mouth 86 that inflator 50 shown in FIG. 1B communicates with the interior of cushion 70 to drive airbag module 10 from the installed state thereof shown in FIG. 1A into the deployed state thereof shown in FIG. 1B. In addition, a flexible, rectangular packaging cover 88 is secured, by a longitudinal edge thereof that is obscured in FIG. 2, to the exterior of one of the pair of opposed portions of main panel 80 that participate in creating neck portion 76 of cushion 70.

A construction seam 90 that is visible only in parts in FIG. 2 centrally traverses the portions of each of main panel 80, near side panel 82, and far side panel 84 that participate in creating neck portion 76 of cushion 70. Packaging cover 88 is secured to the exterior of main panel 80 at the part of construction seam 90 that traverses main panel 80 and is visible in FIG. 2.

Additionally, secured to the exterior of neck portion 76 of cushion 70 by the various parts of construction seam 90 are structures for an inflatable cushion of an airbag module incorporating teachings of the present invention that cooperate with other structures yet to be discussed and secure neck portion 76 of cushion 70 to occupant enclosure 12 at deployment window 36 in airbag installation bracket 78 as shown in FIG. 1B. Thus, attached at construction seam 90 to the exterior of main panel 80 are a flexible attachment tab 100A on the same side of main panel 80 as packaging cover 88 and another flexible attachment tab 100B on the side of main panel 80 opposite therefrom. Attached at construction seam 90 to the exterior of near side panel 82 is a flexible attachment tab 102, while attached at construction seam 90 to the exterior of far side panel 84 is a flexible attachment tab 104. Although visible in FIG. 2 only relative to attachment tab 102, all of the attachment tabs have one or more restraining apertures 106 formed therethrough. Additional examples of such restraining apertures 106 can be seen in FIG. 2 formed through the free edge 108 of packaging cover 88.

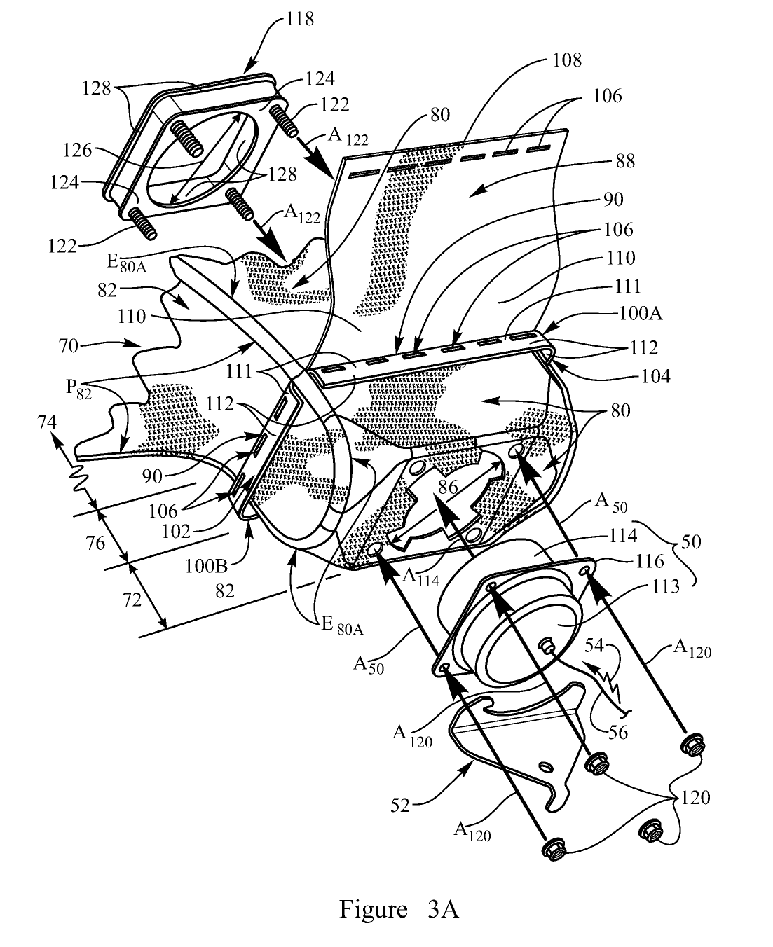

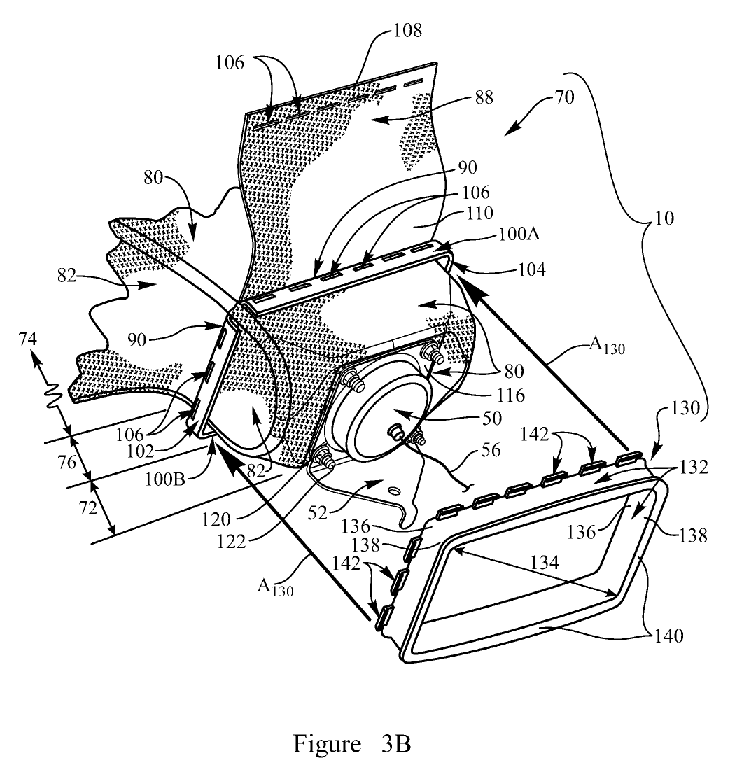

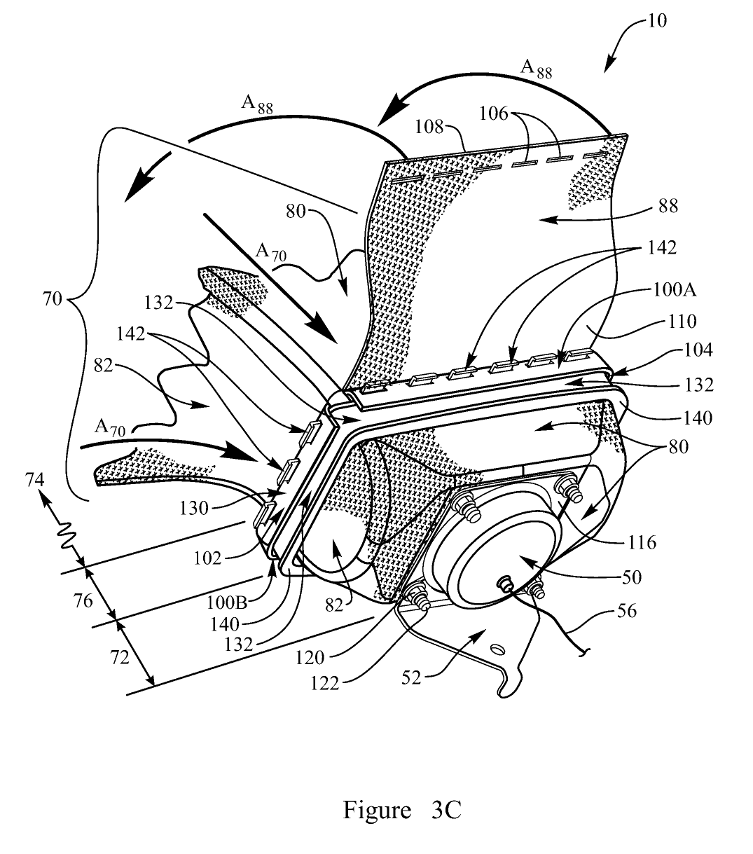

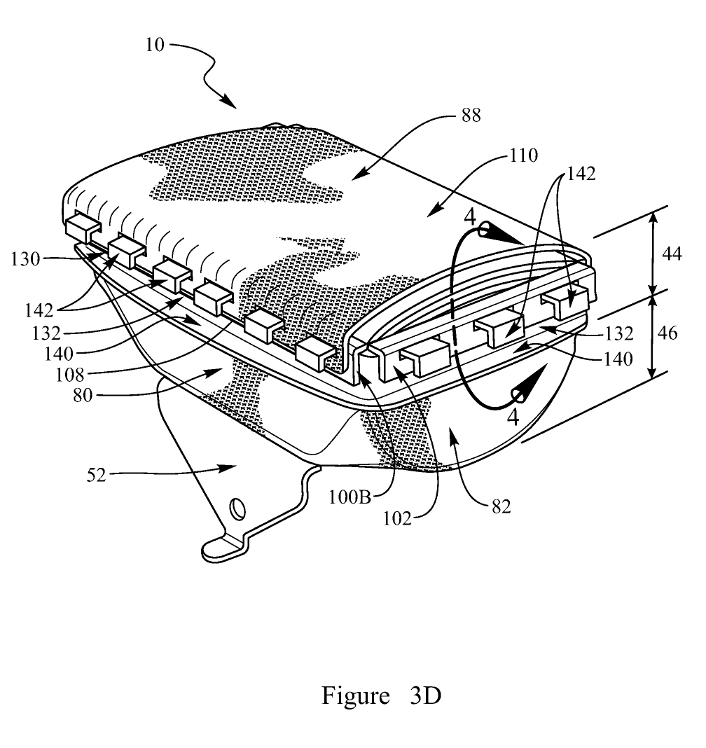

FIG. 3A is a perspective view of the end of cushion 70 that functions as activation portion 72 thereof. Opposite from free edge 108 of packaging cover 88 can be seen a securement edge 110 of packaging cover 88 that is attached to main panel 80 of cushion 70 at construction seam 90. Also revealed in FIG. 3A is that each of attachment tabs 100A, 100B, 102, and 104 includes a longitudinal securement edge 111 that is attached to the exterior of neck portion 76 of cushion 70 and a free edge 112 opposite therefrom. Restraining apertures 106 are formed through each of attachment tabs 100A, 100B, 102, and 104 in a spaced-apart relation parallel and adjacent to securement edge 111 thereof.

Inflator 50 of energizer section 46 of airbag module 10 is shown in FIG. 3A detached from cushion 70. Revealed as a result is inflation mouth 86 through which pressurized gas from inflator 50 enters and inflates cushion 70. Inflator 50 includes a generation end 113 in which pressurized gas is produced in response to activation signal 54 on electrical wire 56, an ejection end 114 opposite thereto from which that pressurized gas is directed into cushion 70, and an encircling mounting flange 116 by which inflator 50 is secured, both to mounting bracket 52, and to the end of cushion 70 that functions as activation portion 72 thereof.

As suggested by arrows A₅₀ and arrow A₁₁₄, inflator 50 is assembled to the exterior of activation portion 72 of cushion 70 with ejection end 114 of inflator 50 projecting through inflation mouth 86. An inflator retainer ring 118 is secured through activation portion 72 of cushion 70 to inflator 50 using cooperating nuts 120 and bolts 122. Bolts 122 project from the face 124 of retainer ring 118 that is oriented toward inflator 50 and activation portion 72 of cushion 70. Arrows A₁₂₀ and arrows A₁₂₂ suggest this assembly. As a result, the portion of cushion 70 surrounding inflation mouth 86 is clamped between face 124 of retainer ring 118 and the side of mounting flange 116 of inflator 50 that is oriented toward activation portion 72 of cushion 70 and that is, therefore, not visible in FIG. 3A. An enlarged opening 126 formed through face 124 of retainer ring 118 receives ejection end 114 of inflator 50. The walls 128 of retainer ring 118 protect adjacent portions of cushion 70 from damage by pressurized gas leaving ejection end 114 of inflator 50.

It should be noted that FIGS. 2 and 3A do not together constitute an assembly sequence for cushion 70 of airbag module 10. It is necessary that inflator 50 and retainer ring 118 be assembled at inflation mouth 86 of cushion 70 as suggested in FIG. 3A before, rather than after, cushion 70 becomes a closed structure in the manner suggested in FIG. 2. In this context it is also worth emphasis that FIG. 2 itself is not an assembly diagram, as there exist many ways to manufacture cushion 70 as a closed structure. Also, the planar qualities exhibited in FIG. 2 in main panel 80, near side panel 82, and far side panel 84 have been adopted for convenience of depiction only. Selected portions of near side panel 82 and of far side panel 84 may be attached to corresponding portions of main panel 80 at various distinct occasions during the manufacture of cushion 70. The entirety of near side panel 82 or the entirety far side panel 84 may be integrally formed with main panel 80, or selected portions of each or of both may be so formed.

For example, the extreme ends of cushion 70 are constructed initially as distinct components. A first such end of cushion 70 would include all of activation portion 72 and the region of neck portion 76 adjacent thereto. A second such end of cushion 70 would correspondingly include all of inflation portion 74 and the region of neck portion 76 adjacent thereto. Once inflator 50 and retainer ring 118 are assembled at inflation mouth 86 to the first end of cushion 70, the first and second ends of cushion 70 are secured together about construction seam 90. This produces cushion 70 as a closed structure with retainer ring 118 disposed in the interior thereof.

FIG. 3B is a perspective view of inflator 50 assembled to activation portion 72 of cushion 70. Also shown is a support collar 130 for airbag module 10. Support collar 130 is a rigid structure that includes a continuous, planar wall 132. Wall 132 defines an enlarged passageway 134 that extends through support collar 130. The cross-sectional shape and size of passageway 134 are similar to the cross-sectional shape and size of the exterior of neck portion 76 of cushion 70.

Wall 132 of support collar 130 is bounded between a cushion attachment edge 136 and an opposed, generally parallel reinforcement edge 138. A continuous lip 140 projects outwardly from wall 132 and away from passageway 134 at reinforcement edge 138, adding to the structural rigidity of support collar 130. At cushion attachment edge 136, support collar 130 is circumscribed by a plurality of cushion hooks 142 that each open toward reinforcement edge 138 of support collar 130. Cushion hooks 142 project outwardly from the exterior periphery of wall 132 in a one-to-one positional correspondence to individual of the restraining apertures 106 formed through respective of attachment tabs 100A, 100B, 102, and 104.

As suggested in FIG. 3B by arrows A₁₃₀, support collar 130 is attached to the exterior of neck portion 76 of cushion 70 in a circumscribing relation thereto. Inflator 50 and activation portion 72 of cushion 70 are advanced through passageway 134 in support collar 130. Attachment tabs 100A, 100B, 102, and 104 encounter cushion attachment edge 136 of wall 132 of support collar 130, and each of cushion hooks 142 on support collar 130 is made to extend through an individual corresponding restraining aperture 106 in one of those attachment tabs. This captures the attachment tabs and retains cushion 70 in support collar 130 with neck portion 76 of cushion 70 extending through passageway 134 of support collar 130. The result is the assembled airbag module 10 illustrated in FIG. 3C.

The assembled airbag module 10 of FIG. 3C must, however, be packaged further before being ready to be installed in a vehicle, such as in vehicle 14 in FIG. 1A. First, as suggested by arrows A₇₀ in FIG. 3C, inflation portion 74 of cushion 70 is deflated and disposed in a compact condition interior of support collar 130 within neck portion 76. Then, as suggested by arrows A₈₈ in FIG. 3C, free edge 108 of packaging cover 88 is lifted across support collar 130 to the far side thereof, closing cushion 70 therein. Free edge 108 of packaging cover 88 is attached directly to the far side of support collar 130 through the interactions of cushion hooks 142 there with restraining apertures 106 at free edge 108 of packaging cover 88. In this condition, free edge 108 of packaging cover 88 overlies attachment tab 100B, and both attachment tab 100B and packaging cover 88 are secured to support collar 130 by the same set of cushion hooks 142. The result is the packaged airbag module 10 shown in FIG. 3D, which is in turn then capable of assuming an installed state of airbag module 10 through being disposed in installation brackets 78 as in FIG. 1B.

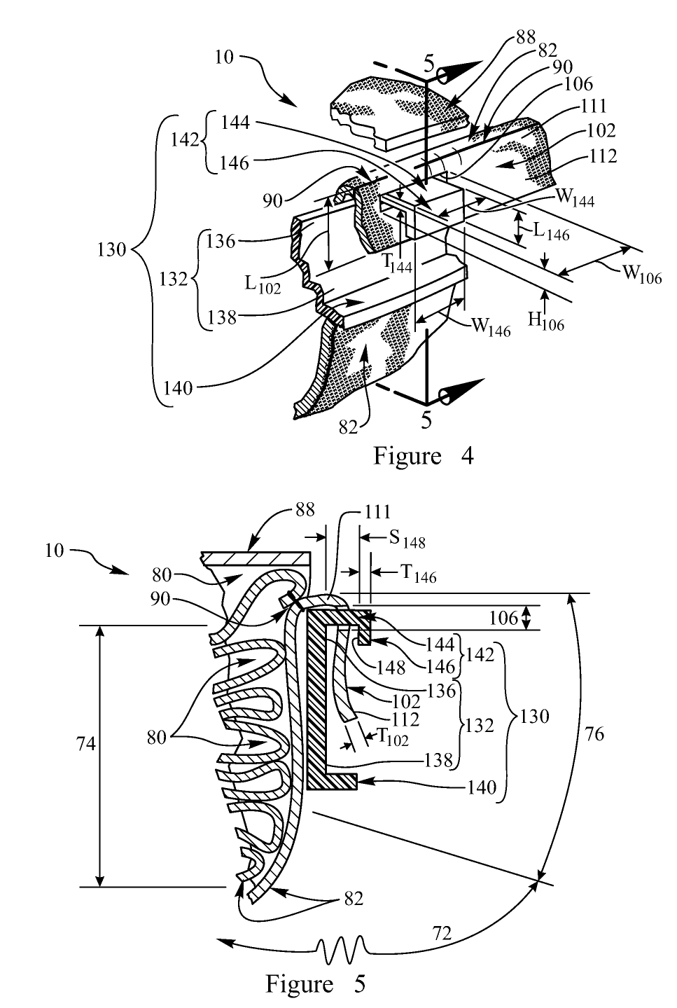

FIGS. 4 and 5 taken together afford an understanding of the manner in which a cushion hook 142 and a restraining apertures 106 cooperate to retain cushion 70 in support collar 130. FIG. 4 is an enlarged detailed perspective view of the portion of FIG. 3D identified by detail arrow 4-4 therein. FIG. 5 is an elevation cross section of FIG. 4 taken along section line 5-5 therein.

The cushion hook 142 shown includes a stub 144 that projects outwardly from cushion attachment edge 136 of wall 132 of support collar 130 in the same direction as lip 140. A finger 146 extends from the end of stub 144 that is remote from wall 132 of support collar 130 toward lip 140 generally normal to stub 144 and parallel to wall 132 of support collar 130. In this manner finger 146 and wall 132 define therebetween an opening 148 into cushion hook 142 that exhibits a size S₁₄₈ shown in FIG. 5. Opening 148 into cushion hook 142 is thus also oriented toward lip 140 of support collar 130. Each of stub 144 and finger 146 has a transverse cross section that is substantially rectangular. As shown in FIGS. 4 and 5, stub 144 has a width W₁₄₄, a length L₁₄₄, and a thickness T₁₄₄. Finger 146 has a width W₁₄₆, a length L₁₄₆, a thickness T₁₄₆. Width W₁₄₆ of finger 146 is equal to width W₁₄₄ of stub 144, thereby defining a common width for cushion hook 142.

The restraining aperture 106 shown is rectangular in cross-sectional shape, exhibiting a width W₁₀₆ and a height H₁₀₆ that are identified in FIG. 4. Width W₁₀₆ of restraining aperture 106 is approximately equal to or slightly greater than width W₁₄₄ of sub 144 of cushion hook 142. Similarly, height H₁₀₆ of restraining aperture 106 is approximately equal to or slightly greater than thickness T₁₄₄ of stub 144. Once cushion hook 142 has been made to extend through restraining aperture 106 in the process of assembling airbag module 10, these relative size relationships between restraining aperture 106 and stub 144 afford restraining aperture 106 a tight grip about stub 144 of cushion hook 142. The grip of restraining aperture 106 about stub 144 of cushion hook 142 is made additionally secure when size S₁₄₈ of opening 148 into cushion hook 142 is approximately equal to or slightly greater than the thickness T₁₀₂ of attachment tab 102 itself. To facilitate assembly, the length L₁₀₂ of attachment tab 102 is greater than length L₁₄₆ of finger 146 of cushion hook 142.

Advantageously, in the manner illustrated in FIGS. 4 and 5, neck portion 76 of cushion 70 is attached in a fastener-free manner directly to support collar 130 without resort to additional components or materials. Manufacturing complexity is reduced as a result.

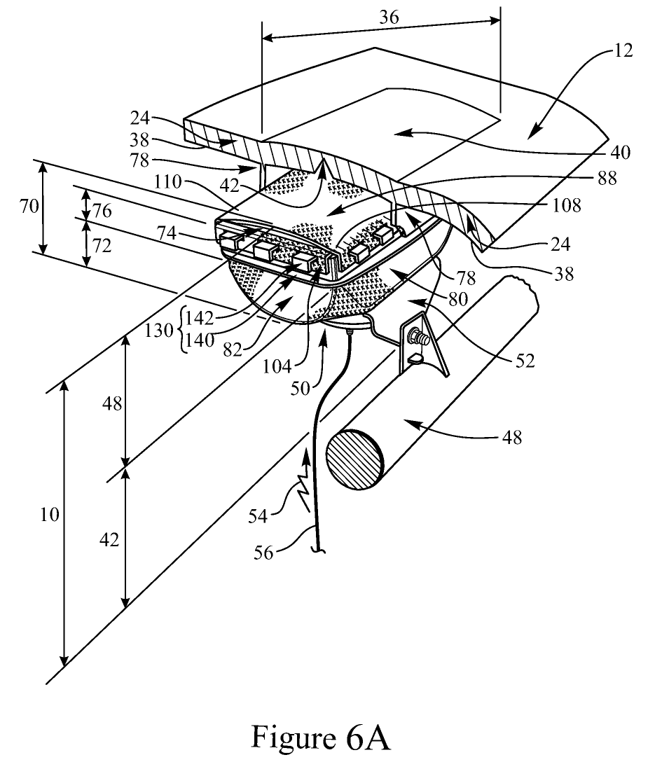

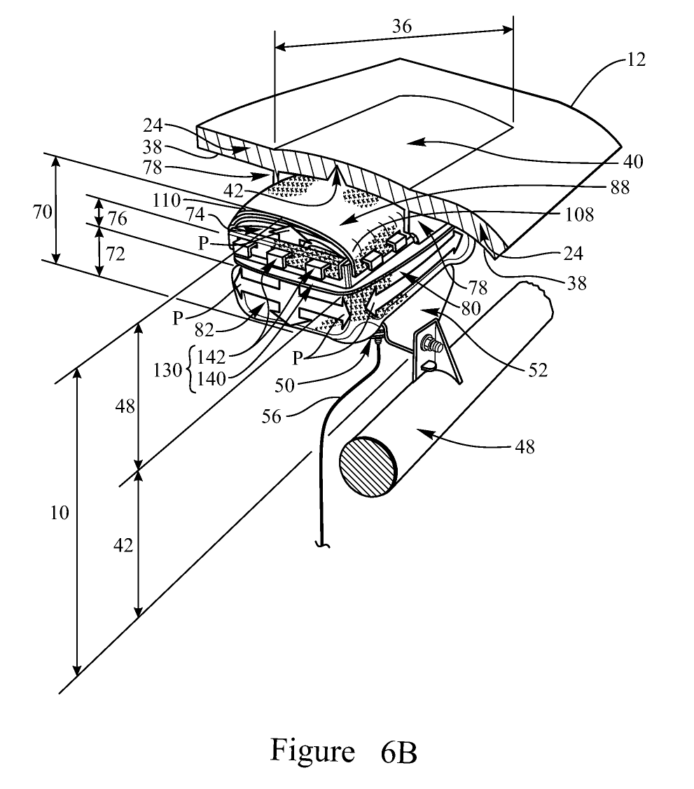

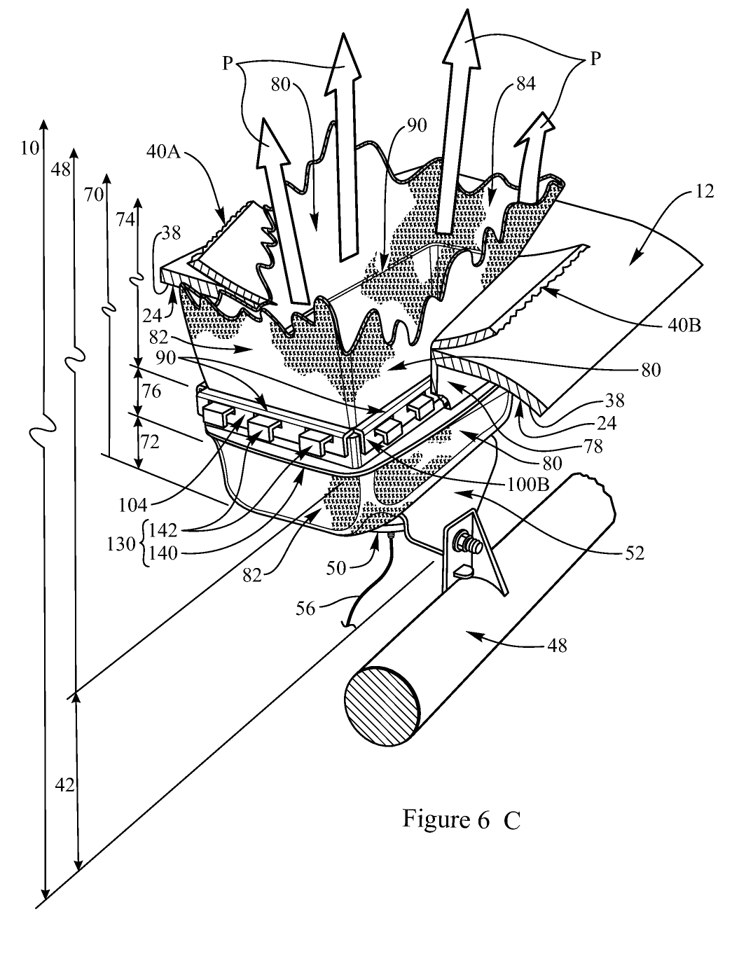

FIGS. 6A-6C form a series of perspective illustrations in partial cross section that depict stages in the deployment of cushion 70 of airbag module 10 of FIG. 3D.

FIG. 6A illustrates airbag module 10 installed on exterior surface 38 of instrument panel 24 of occupant enclosure 12 at deployment window 36. Support collar 130 of airbag module 10 is retained between airbag installation brackets 78 in readiness to deploy cushion 70 through deployment window 36 in response to activation signal 54 received along electrical wire 56 by inflator 50.

FIG. 6B illustrates airbag module 10 at an initial stage of activation, approximately 7 milliseconds following commencement of the generation of pressurized gas by inflator 50, but prior to the breakout of cushion 70 through deployment window 36. Inflation portion 74 of cushion 70 was previously housed in a compact state inside neck portion 76 and activation portion 72 of cushion 70 circumscribed for the most part by support collar 130. Pressurized gas from inflator 50 rapidly fills cushion 70 in that state, causing the various portions of cushion 70 to expand abruptly in all directions, as suggested by pressure arrows P. Activation portion 72 of cushion 70, being supported by inflator 50 and mounting bracket 52 from structural element 48, is prevented from engaging in movement away from or parallel to instrument panel 24. Neck portion 76 of cushion 70, being circumscribed by support collar 130, is unable to expand, while the retention of support collar 130 within airbag installation brackets 78 prevents neck portion 76 of cushion 70 from engaging in movement away from deployment window 36 or parallel to instrument panel 24.

Consequently, inflation portion 74 of cushion 70 is the only portion of cushion 70 that is capable of any degree of expansion in response to the pressurized gas from inflator 50. Thus, inflation portion 74 of cushion 70 fills rapidly, surging out of neck portion 76 and activation portion 72 of cushion 70 toward deployment window 36. The expanding inflation portion 74 first encounters packaging cover 88, which is designed to tear readily, releasing inflation portion 74 to impact exterior surface 38 of occupant enclosure 12 at release groove 42 in concealment panel 40.

Then, as illustrated in FIG. 6C, concealment panel 40 splits along release groove 42 into an upper concealment panel segment 40A and a lower concealment panel segment 40B. Under the continuing impetus of the expansion of inflation portion 74, each of upper concealment panel segment 40A and a lower concealment panel segment 40B pivot about a respective portion of the periphery of deployment window 36 toward the interior of occupant enclosure 12, opening deployment window 36. As suggested by pressure arrows P in FIG. 6C, inflation portion 74 of cushion 70 is then driven by the pressurized gas from inflator 50 toward a fully inflated condition thereof in the interior of occupant enclosure 12. When inflation portion 74 reaches the fully inflated condition thereof, the movement of inflation portion 74 into the interior of occupant enclosure 12 is curtailed by the attachment of airbag module 10 to occupant enclosure 12 between airbag installation brackets 78. As a result, snap-loads then arise in the material structure of cushion 70.

Ultimately, the snap-loads are resolved at neck portion 76 of cushion 70. There snap-loads are distributed on construction seam 90, where the body of cushion 70 is secured to the attachment tabs of cushion 70, namely to attachment tabs 100B and 104 shown in FIG. 6C and to attachment tabs 100A and 102 not visible therein. Neck portion 76 of cushion 70 is sustained in an open condition in a fixed relationship to occupant enclosure 12 by support collar 130 and the interaction of cushion hooks 142 thereof with the attachment tabs on cushion 70.

As seen to good advantage in FIG. 3C, the extent of the interface between support collar 130 and neck portion 76 of cushion 10 is substantial, when compared for example with the extent of the interface arising between mounting flange 116 of inflator 50 and activation portion 72 of cushion 70. According the distribution on construction seam 90 of snap loads produced by the deployment of cushion 70 is advantageously less intense per unit length of interface than would be the case were cushion 70, for example, instead restrained against snap-loads at inflator 50. This feature of an airbag module incorporating teachings of the present invention contributes to maintaining the structural integrity of the cushion of the airbag module during deployment

The footprint at which snap-loads are resolved in airbag module 10, at the interface between support collar 130 and neck portion 76 of cushion 10, is relatively large. This results in substantial deployment stability once cushion 70 is inflated, as compared for example with the deployment stability that could be produced by resolving snap-loads at an interface between mounting flange 116 of inflator 50 and activation portion 72 of cushion 70.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within the scope thereof.

What is claimed is:

1. An airbag module for protecting a rider in a vehicle from impacting the interior of the occupant enclosure of the vehicle, said module comprising:
a rigid support collar for attachment to the occupant enclosure at an airbag deployment window formed therethrough; and
an inflatable cushion having a neck portion accommodative of pressurized gas for driving said cushion through said deployment window into an inflated condition within the occupant enclosure, said neck portion of said cushion engaging said support collar and said cushion being housed in a compact condition within said neck portion.

2. An airbag module as recited in claim 1, wherein:
said cushion further comprises an attachment tab disposed on the exterior of said neck portion of said cushion with a restraining aperture formed therethrough; and
said support collar further comprises a cushion hook on the exterior of said support collar, said cushion hook extending through said restraining aperture and preventing displacement of said neck portion of said cushion out of said support collar when pressurized gas inflates said cushion.

3. An airbag module as recited in claim 1, wherein:
said cushion further comprises:
an elongated flexible attachment tab having a longitudinal securement edge disposed on the exterior of said neck portion of said cushion and a free edge remote from said securement edge; and
a plurality of restraining apertures formed through said attachment tab in a spaced-apart relationship generally parallel to said securement edge thereof; and
said support collar further comprises a plurality of cushion hooks on the exterior of said support collar disposed such that each of said cushion hooks receives one of said restraining apertures for capturing said attachment tab.

4. An airbag module as recited in claim 1, wherein:
said cushion further comprises:
a plurality of flexible attachment tabs circumscribing the exterior of said neck portion of said cushion, each of said attachment tabs having a securement edge disposed on the exterior of said neck portion of said cushion and a free edge remote from the securement edge; and
a restraining aperture associated with and formed through each of said attachment tabs between said securement edge and said free edge thereof; and
said support collar further comprises a circumscribing plurality of cushion hooks on the exterior of said support collar disposed such that each of said cushion hooks receives one of said restraining apertures for capturing said attachment tab, said plurality of cushion hooks thereby cooperating with said attachment tab in absorbing at said neck portion of said cushion snap-loads arising when pressurized gas fully inflates said cushion.

5. An airbag module as recited in claim 1, wherein said cushion further comprises a flexible packaging cover having opposed first and second edges, said first edge of said packaging cover being secured to said neck portion of said cushion, said second edge of said packaging cover being secured to said support collar, and said packaging cover therebetween extending across said support collar retaining therein said cushion in said compact condition within said neck portion.

6. An airbag module as recited in claim 1, wherein said support collar assumes the form of a closed loop configured to circumscribe the airbag deployment window formed through the occupant enclosure.

7. An airbag module as recited in claim 6, wherein said support collar further comprises a plurality of cushion hooks circumscribing said support collar disposed on the exterior of said support collar in spaced-apart relation, each of said cushion hooks opening away from the occupant enclosure when said support collar is secured to the exterior of the occupant enclosure, and each of said cushion hooks interacting with features on said neck portion of said cushion to prevent displacement of said neck portion of said cushion out of said support collar when pressurized gas inflates said cushion.

8. An airbag module for protecting a rider in a vehicle from impacting the interior of the occupant enclosure of the vehicle, said module comprising:
an inflatable cushion comprising:
a closed-ended inflation portion housed in a compact condition proximate to a deployment window formed through the occupant enclosure, said inflation portion of said cushion being drivable by pressurized gas through said deployment window into an inflated condition within in the occupant enclosure;
an activation portion maintained in substantially unchanged disposition exterior of the occupant enclosure during all conditions of said inflation portion; and
a neck portion interconnecting said inflation portion and said activation portion in fluid-tight communication, said neck portion accommodating the transfer of pressurized gas from said activation portion into said inflation portion;
a rigid support collar for disposition at to the exterior of the occupant enclosure proximate the airbag deployment window, said support collar engaging in circumscribing relation the exterior of said neck portion of said cushion such that said inflation portion of said cushion is housed in said compact condition within said neck portion; and
an inflator productive of pressurized gas responsive to an activation signal, said inflator in fluid-tight communication with said activation portion.

9. An airbag module as recited in claim 8, further comprising a retainer ring secured to said inflator through a wall of said activation portion of said cushion.

10. An airbag module as recited in claim 8, further comprising a mounting bracket secured to said inflator for supporting said inflator from a structural element of the vehicle.

11. An airbag module as recited in claim 8, wherein said cushion further comprises a flexible packaging cover having opposed first and second edges, said first edge of said packaging cover being secured to said neck portion of said cushion, said second edge of said packaging cover being secured to said support collar, and said packaging cover therebetween extending across said support collar retaining therein said cushion in said compact condition within said neck portion.

12. An airbag module as recited in claim 8, wherein:
said cushion further comprises a flexible attachment tab disposed on the exterior of said neck portion of said cushion and having a restraining aperture therethrough; and
said support collar further comprises a cushion hook disposed on the exterior periphery of said support collar, said cushion hook extending through said restraining aperture and preventing displacement of said neck portion of said cushion out of said support collar when pressurized gas inflates said inflation portion of said cushion.

13. An airbag module for protecting a rider in a vehicle from impacting the interior of the occupant enclosure of the vehicle, said module comprising:
a deployment section for disposition proximate to the occupant enclosure at an airbag deployment window formed therethrough, said deployment section being drivable to position a gas-inflated impact-absorbing cushion within the interior of the occupant enclosure by way of the deployment window, and said deployment section absorbing snap loads arising from so positioning said cushion; and
an energizer section for support from the vehicle independently of said deployment section, said energizer section being in inflation communication with said deployment section, and said energizer section delivering pressurized gas to said deployment section when an impact is imminent between the rider and the interior of the occupant enclosure.

14. An airbag module as recited in claim 13, wherein said deployment section comprises:
an inflatable cushion comprising:
a closed-ended inflation portion housed in a compact condition and disposed proximate the deployment window, said inflation portion of said cushion being drivable by pressurized gas through the deployment window into an inflated condition within the occupant enclosure; and
a neck portion in fluid-tight communication with said inflation portion of said cushion and said energizer section, said neck portion accommodating the transfer of pressurized gas from said energizer section into said inflation portion; and
a rigid support collar for disposition proximate to the occupant enclosure at the airbag deployment window, said support collar being in circumscribing relation to the exterior of said neck portion of said cushion and such that said neck portion houses said inflation portion of said cushion in said compact condition.

15. An airbag module as recited in claim 14, wherein said support collar further comprises a plurality of cushion hooks circumscribing and disposed on the exterior periphery of said support collar in spaced-apart relation, each of said cushion hooks for interacting with features on said neck portion of said cushion to prevent displacement of said neck portion of said cushion out of said support collar when said inflation portion of said cushion is driven through the deployment window into said inflated condition within the occupant enclosure.

16. An airbag module as recited in claim 14, wherein said cushion further comprises a flexible packaging cover having opposed first and second edges, said first edge of said packaging cover being secured to said neck portion of said cushion, said second edge of said packaging cover being secured to said support collar, and said packaging cover therebetween extending across said support collar retaining therein said cushion in said compact condition within said neck portion.

17. An airbag module as recited in claim 13, wherein said energizer section comprises:
an activation portion of said cushion maintained in substantially unchanged disposition exterior of the occupant enclosure during all conditions of said inflation portion of said cushion;
an inflator productive of pressurized gas responsive to an activation signal, said inflator being in fluid communication with the interior of said activation portion;
a retainer ring secured to said inflator through a wall of said activation portion of said cushion; and
a mounting bracket secured to said inflator for supporting said inflator from a structural element of the vehicle.
